(19) United States
(12) Patent Application Publication
(10) Pub. No.: US 2016/0075567 A1
(43) Pub. Date: Mar. 17, 2016

(54) MANUFACTURE OF OXIDATIVELY MODIFIED CARBON (OMC) AND ITS USE FOR CAPTURE OF RADIONUCLIDES AND METALS FROM WATER

(71) Applicant: WILLIAM MARSH RICE UNIVERSITY, Houston, TX (US)

(72) Inventors: James M. Tour, Bellaire, TX (US); Ayrat Dimiev, Basking Ridge, NJ (US); Elena Dimieva, Basking Ridge, NJ (US)

(21) Appl. No.: 14/888,239

(22) PCT Filed: May 2, 2014
(86) PCT No.: PCT/US2014/036543

§ 371 Date: Oct. 30, 2015

Related U.S. Application Data
(60) Provisional application No. 61/818,654, filed on May 2, 2013.

(51) Int. Cl. C02F 1/28; C01B 31/00; B01J 20/20; B01J 20/30; C02F 1/00; C02F 1/38

(52) U.S. Cl. CPC C02F 1/283; C02F 1/001; C02F 1/38; B01J 20/20; B01J 20/3085; C01B 31/00; C02F 2101/006

(57) ABSTRACT

In some embodiments, the present disclosure pertains to methods of capturing contaminants (i.e., radionuclides and metals) from a water source by applying an oxidatively modified carbon to the water source. This leads to the sorption of the contaminants in the water source to the oxidatively modified carbon. In some embodiments, the methods also include a step of separating the oxidatively modified carbon from the water source after the applying step. In some embodiments, the oxidatively modified carbon comprises an oxidized carbon source. In some embodiments, the carbon source is coal. In some embodiments, the oxidatively modified carbon comprises oxidized coke. In some embodiments, the oxidatively modified carbon is in the form of free-standing, three dimensional and porous particles. Further embodiments of the present disclosure pertain to materials for capturing contaminants from a water source, where the materials comprise the aforementioned oxidatively modified carbons.

### CROSS-REFERENCE TO RELATED APPLICATIONS

This application claims priority to U.S. Provisional Patent Application No. 61/818,654, filed on May 2, 2013. The entirety of the aforementioned application is incorporated herein by reference.

### STATEMENT REGARDING FEDERALLY SPONSORED RESEARCH

Not applicable.

### BACKGROUND

Current methods of removing radioactive elements and metals from water have numerous limitations in terms of cost, efficiency and versatility. The present disclosure addresses these limitations.

### SUMMARY

In some embodiments, the present disclosure pertains to a method of capturing contaminants from a water source. In some embodiments, the contaminants are selected from the group consisting of radionuclides, metals, and combinations thereof. In some embodiments, the method comprises applying an oxidatively modified carbon to the water source, where the applying leads to sorption of the contaminants in the water source to the oxidatively modified carbon. In some embodiments, the method further comprises a step of separating the oxidatively modified carbon from the water source after the applying step.

In some embodiments, the oxidatively modified carbon comprises an oxidized carbon source, where the carbon source is selected from the group consisting of coal, coke, charcoal, asphalt, asphaltenes, activated carbon, and combinations thereof. In some embodiments, the carbon source is coal. In some embodiments, the carbon source is coke. In some embodiments, the oxidatively modified carbon comprises oxidized coke.

In some embodiments, the oxidatively modified carbon has a three-dimensional structure. In some embodiments, the oxidatively modified carbon is free-standing. In some embodiments, the oxidatively modified carbon is in the form of particles. In some embodiments, the oxidatively modified carbon comprises a plurality of pores. In some embodiments, the oxidatively modified carbon comprises a plurality of layers. In more specific embodiments, the oxidatively modified carbon has a layered structure with nano-sized and micro-sized openings between the layers.

In some embodiments, the oxidatively modified carbon is applied to the water source in solid or liquid forms. In some embodiments, the oxidatively modified carbon is applied to the water source by dispersing the oxidatively modified carbon in the water source. In some embodiments, the oxidatively modified carbon is applied to the water source by flowing the water source through a structure housing the oxidatively modified carbon. In some embodiments, the structure is a column or a filter. In some embodiments, a cross-flow (also referred to as a tangential flow) filtering system is used to capture contaminants from a water source, where the oxidatively modified carbon remains inside the cross-flow filtering system with captured contaminants (e.g., metals and radionuclides) while the purified water source passes through the cross-flow filtering system.

In some embodiments, the oxidatively modified carbon is applied to the water source while the oxidatively modified carbon is compartmentalized. In some embodiments, the oxidatively modified carbon is compartmentalized in a porous container. In some embodiments, that porous container can be flexible and can resemble a large teabag or sock-like structure.

In some embodiments, the sorption of the contaminants in the water source to the oxidatively modified carbon comprises absorption or adsorption (or both) of the contaminants to the oxidatively modified carbon. In some embodiments, the sorption results in the capture of at least about 50% of the contaminants in the water source. In some embodiments, the sorption results in the capture of at least about 90% of the contaminants in the water source. In some embodiments, the water source is repeatedly flowed through a structure housing the oxidatively modified carbon so as to remove more of the contaminants from the water source with each pass.

In some embodiments, the present disclosure pertains to methods of preparing oxidatively modified carbon by oxidizing a carbon source. In some embodiments, the oxidizing comprises exposing the carbon source to an oxidant, such as permanganates, chlorates, perchlorates, hypochlorites, hypobromites, hypoiodites, chromates, dichromates, nitrates, nitric acid, sulfuric acid, oleum, chorosulfonic acid, and combinations thereof. In more specific embodiments, the oxidants include, without limitation, potassium permanganate, potassium chlorate, nitric acid, sulfuric acid, hydrogen peroxide, ozone, and combinations thereof.

Further embodiments of the present disclosure pertain to materials for capturing contaminants from a water source. In some embodiments, the material comprises an oxidatively modified carbon of the present disclosure. In some embodiments, the oxidatively modified carbon is in the form of free-standing and three-dimensional porous particles.

### DESCRIPTION OF THE FIGURES

FIG. 1 provides a scheme of a method for capturing contaminants from a water source.

FIG. 2 provides scanning electron microscopy (SEM) images of an oxidatively modified carbon (OMC) at different magnifications. FIGS. 2A-D provide images of OMCs prepared by the oxidation of one type of coke (Coke A). Coke A is a coke made from pitch (a heavy fraction of crude oil) by high temperature treatment. The oxidation included treatment of the coke by a potassium permanganate solution in sulfuric acid (KMnO₄/H₂SO₄). After oxidation, Coke A retained its porous structure. FIGS. 2E-H provide images of OMCs prepared by the oxidation of another type of coke (Coke B). Coke B is a metallurgical coke made by thermal treatment of bituminous coals. Coke B was oxidized by a nitric acid-sulfuric acid mixture (HNO₃/H₂SO₄). After oxidation, Coke B retained its highly porous, lamellar structure. The pore sizes are in the micron and submicron scales.

FIG. 3 provides C1s x-ray photoelectron spectroscopy (XPS) spectra for Coke A (black line) and OMCs prepared by the oxidation of the coke by a KMnO₄/H₂SO₄ solution (red line). The peak at 288 eV shows that the OMC surface is heavily oxidized.

FIG. 4 provides thermogravimetric analysis (TGA) data for Coke A (black line) and OMC prepared by the oxidation of the coke (red line).

FIG. 5 provides data relating to the absorbing efficacy of different carbonaceous materials toward three metal cations in a water source (i.e., a natural spring water). The Y-axis is the percentage of ions removed from the solution. The water source tested contained Eu(III), Cs, and Sr. Each of the metals had a concentration of 5.0×10⁻⁷ mol/L in the water source.

FIG. 6 provides data relating to the efficacy of OMCs in removing metal cations from the water source described in FIG. 5 while the OMC was immobilized in absorption columns. The Y-axis is the percentage of ions removed from the solution.

FIG. 7 provides data relating to the efficacy of different carbonaceous materials in removing metal cations from the water source described in FIG. 5 through a “tea bag” purification technique. The Y-axis is the percentage of ions removed from the solution.

FIG. 8 provides data relating to the sorption of Sr (II) from freshwater by various OMCs. FIG. 8A shows the sorption of Sr(II) from synthetic and moderately hard water using oxidized cokes (OCs). Here, OMC is OC. The cokes were oxidized by KMnO₄ and H₂SO₄. In some cases, the OC particles were not fractionated, and in other cases they were sized-fractionated prior to use, where mkm represents micrometer and refers to an average particle diameter in micrometers. The sorption is compared to that achieved by a graphene oxide (labeled AZ-GO). This is further compared to commercial activated carbon. 45 g/L of carbon material was used. FIG. 8B shows the same experiments as in FIG. 8A, except that the X-scale is logarithmic. FIG. 8C shows the same experiment as in FIG. 8A but showing the efficacy when the pH was changed.

FIG. 9 provides experimental results relating to the sorption capabilities of OMCs at varying pH levels. FIG. 9A provides a description of three types of experiments with oxidized coke (AD-287), where: (i) the pH was not adjusted with exogenous base; (ii) the pH was held constant by addition of base; and (iii) the pH was not adjusted with exogenous base but at a higher oxidized coke concentration. Without addition of base (ammonium hydroxide), the pH spontaneously lowers over time due to hydronium ion release from the oxidized coke. FIG. 9B compares the efficacy of pH change vs. no pH change for capture of Sr(II) in synthetic moderately hard water. In the second case, a second lowering of the pH was used. FIG. 9C provides the same experiment as in FIG. 9B by using synthetic sea water. FIGS. 9D-E provide data relating to the capture of Cs(I) using the same conditions as in FIG. 9B. FIG. 9F provides a comparative summary of the sorption efficacy of Sr(II) to oxidized coke (AD-287) and graphene oxide using the same conditions as above. FIG. 9G provides a comparative summary of the sorption efficacy of Cs(I) to oxidized coke (AD-287) and graphene oxide using the same conditions as above.

FIG. 10 provides preliminary data relating to the sorption of Sr(II) by oxidized coke in moderately hard water (FIG. 10A) and 25% synthetic sea water in 75% moderately hard water (FIG. 10B). Also shown in both cases are sorption efficacy results before and after the removal of ultra-small particles of the oxidized coke by centrifugation. The x-axis in both plots is the number of grams of oxidized coke per liter of solvent.

FIG. 11 provides data relating to the sorption of Sr(II) and Am(III) by oxidized coke. FIGS. 11A-B provide data relating to the sorption of Sr(II) by oxidized coke in moderately hard fresh water (FIG. 11A) and 25% synthetic sea water in 75% moderately hard fresh water (FIG. 11B). FIG. 11C provides data relating to the study of the sorption of Am(III) in 25% synthetic sea water in 75% moderately hard fresh water. Also shown in all cases are sorption efficacy results before and after the removal of ultra-small particles of the oxidized coke by centrifugation. The x-axis in the plots is the number of grams of oxidized coke per liter of solvent.

FIG. 12 provides preliminary data relating to the sorption efficacies of Sr(II), Cs(I), Am(III) and Y(III) by oxidized coke in moderately hard fresh water, synthetic sea water and 25% synthetic sea water in 75% moderately hard fresh water. The x-axis in the plots in FIGS. 12A-E represent the number of grams of oxidized coke per liter of solvent. In some cases, the smaller oxidized coke particles were removed by centrifugation.

FIG. 13 provides data relating to the sorption efficacies of Sr(II), Cs(I), and Am(III) by oxidized coke in moderately hard fresh water and 25% synthetic sea water in 75% moderately hard fresh water. The x-axis in the plots in FIGS. 13A-C represent the number of grams of oxidized coke per liter of solvent.

FIG. 14 provides comparative data relating to the sorption of Sr(II) and Cs(I) by graphene oxide (prepared in two different labs and termed AZ and Ayrat) and oxidized carbon (also prepared in two different labs). The sorption efficacies shown in FIGS. 14A-B were both conducted in moderately hard fresh water.

FIG. 15 provides comparative data relating to the sorption of Cs(I) and Sr(II) by oxidized coke (AD-294) and graphene oxide (AZ-GO). The x-axis in each plot is the amount of carbon sorbent per liter of solvent.

FIG. 16 provides comparative data relating to the sorption of Am(II) by GO (FIG. 16A) and oxidized coke (FIG. 16B) in fresh water, sea water and a 25/75 mix of the two.

FIG. 17 provides data relating to the sorption of Sr(II) in fresh water by using oxidized coke of differing particle sizes (corresponding to microns in diameter separated further by centrifugation to remove ultra-small particles) and graphene oxide.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Current methods of removing radionuclides and metals from water include sorption of the contaminants by three different types of materials: a) naturally occurring porous materials, such as clays and zeolites; b) porous carbon materials, such as charcoal and activated carbon; and c) ion-exchange resins. The sorption effectiveness of rocky porous materials such as clays or zeolites (e.g., U.S. Pat. Nos. 4,087,374 and 6,531,064) is low, despite their high porosity.

Containment of contaminated absorbent is an additional problem to be solved. For instance, after absorption, the contaminated clays and zeolites with absorbed radionuclides need to be properly stored. However, the volumes of clays and zeolites cannot be reduced.

Moreover, many of the current absorbents have to have structural support. For instance, ion-exchange resins (U.S. Pat. No. 3,340,200) require structural support. However, such requirement for structural support increases the costs and limits the effective surface areas of the ion-exchange resins.

Charcoal, activated charcoal and activated carbon all have very high surface areas. In addition, the aforementioned carbon materials are effectively used for sorption of numerous contaminants from numerous environments. For instance, “activated coke” is produced by treatment of raw coke with steam at 900° C. In fact, activated coke has been used for gaseous phase removal of SOₓ, NOₓ and Hg (U.S. Pat. No. 5,270,279). However, activated coke has not been used for removing radionuclides or metals from water sources. Moreover, the effectiveness of such carbon materials towards removing radionuclides and metals from water sources is not very high. In fact, oxidation of coke with strong oxidants and acids in liquid phase with the aim of preparing sorbing material was never reported. In addition, specific types of activated carbons (e.g., “MaxSorb”) are expensive.

Recently, a method of sorption of radionuclides by graphene oxide (GO) was demonstrated (Romanchuk et al., Phys. Chem. Phys. 2013, 15, 2321-2327 DOI: 10.1039/c2cp44593j and PCT/US2012/026766). Despite its effectiveness in removing radionuclides, GO has several limitations.

A first limitation is the cost of preparing GO. For instance, when GO is prepared by liquid phase oxidation of graphite with strong oxidants, four to six weight equivalences (wt. eq.) of oxidants (such as potassium permanganate) are required to exfoliate graphite oxide to single atomic layers of GO flakes. In addition, the cost of only one wt. eq. of oxidant is roughly three to five times higher than the cost of graphite itself. Moreover, the oxidation reaction is conducted in concentrated sulfuric acid, which is difficult to recycle. Furthermore, the washing of GO with water produces significant amounts of dilute sulfuric acid waste. In addition, removing acids from the GO is slow and time consuming. Such limitations make GO more expensive to produce.

A second limitation of using GOs to remove radionuclides and metals from water sources is the difficulty of the purification procedures. GO can be easily dispersed in contaminated water due to its hydrophilicity. Moreover, GO can effectively capture radionuclide metal ions. However, separation of contaminated GO from as-purified water is a difficult task due to high stability of GO colloid solutions. Moreover, separation by filtration is hampered due to the GO's pore blocking ability. As an alternative strategy, GO can be assembled on solid support materials. However, the engineering of such structures can be costly and impractical.

Therefore, in view of the aforementioned limitations, new methods and materials are required to capture radionuclides and metals from water sources. The present disclosure addresses this need.

In some embodiments, the present disclosure pertains to methods of capturing contaminants from a water source by applying an oxidatively modified carbon to the water source. In some embodiments, the present disclosure pertains to methods of making the oxidatively modified carbons. In additional embodiments, the present disclosure pertains to materials for capturing contaminants from a water source.

Methods of Capturing Contaminants from a Water Source

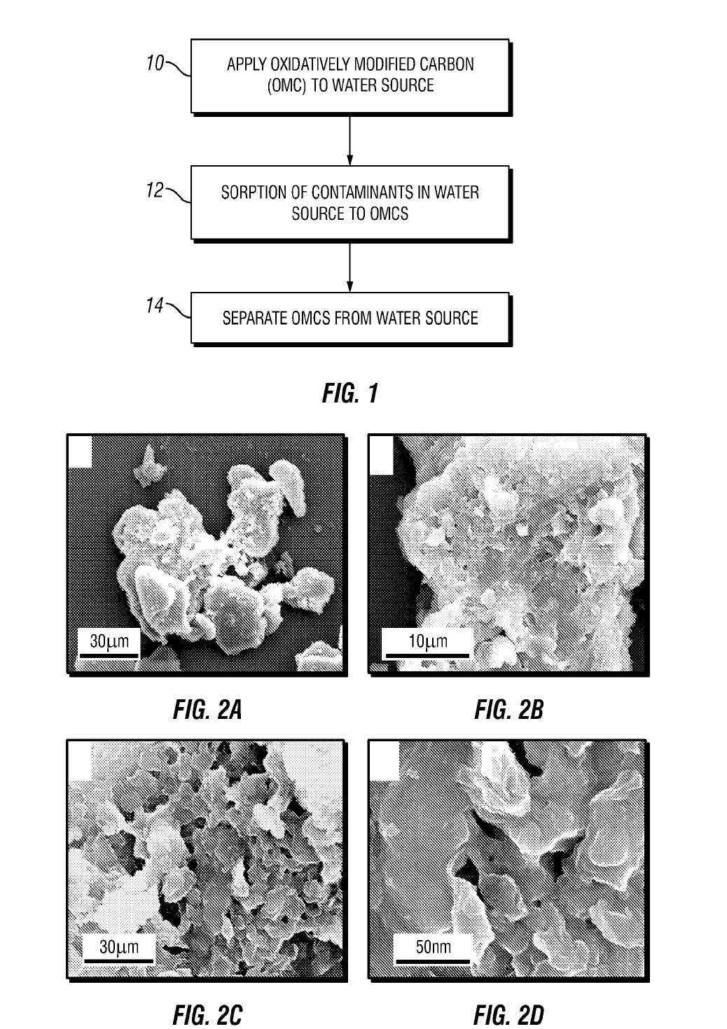

In some embodiments, the present disclosure pertains to methods of capturing contaminants from a water source. In some embodiments, the contaminants that are captured from the water source are radionuclides, metals, and combinations thereof. In some embodiments that are illustrated in the scheme in FIG. 1, the methods of the present disclosure include a step of applying an oxidatively modified carbon to the water source (step 10). This leads to the sorption of the contaminants in the water source to the oxidatively modified carbon (step 12). In some embodiments, the methods of the present disclosure also include a step of separating the oxidatively modified carbon from the water source (step 14).

As set forth in more detail herein, the methods of the present disclosure can apply various types of oxidatively modified carbons to various water sources to remove contaminants from the water sources. In addition, various methods may be utilized to separate the oxidatively modified carbons from the water sources after sorption of the contaminants.

Water Sources

The methods of the present disclosure may be utilized to capture contaminants from various water sources. In some embodiments, the water sources may be contaminated with nuclear waste, such as nuclear fission products. In some embodiments, the water sources may include, without limitation, lakes, oceans, wells, ponds, springs, rivers, water runoff, sea water, or mixtures thereof. In some embodiments, the water sources include cooling water and washing water from nuclear reactors.

In some embodiments, the water sources can include, without limitation, fresh water, natural spring water, hard water, moderately hard water, sea water, or combinations thereof. In some embodiments, the water sources include approximately 25% sea water and 75% fresh water.

In some embodiments, the contents of water sources can affect the capture of contaminants from water sources. For instance, in some embodiments, the capture of heavier metals can be affected in the presence of much higher concentrations of lighter metals, such as sodium.

Contaminants

The methods of the present disclosure may be utilized to capture various types of contaminants from water sources. In some embodiments, the contaminants include radionuclides, metals, and combinations thereof.

In some embodiments, the contaminants to be captured from water sources include radionuclides. In some embodiments, the radionuclides include, without limitation, thallium, iridium, fluorine, americium, neptunium, gadolinium, bismuth, uranium, thorium, plutonium, niobium, barium, cadmium, cobalt, europium, manganese, sodium, zinc, technetium, strontium, carbon, polonium, cesium, potassium, radium, lead, actinides, lanthanides and combinations thereof. In more specific embodiments, the radionuclides to be captured from water sources include, without limitation, europium, cesium, strontium, and combinations thereof.

In some embodiments, the contaminants to be captured from water sources include metals. In some embodiments, the metals include, without limitation, heavy metals, light metals, metal cations, metal oxides, metal halides, metal sulfates, metal hydroxides, mixed metal cations, zero valent metals, and combinations thereof.

In some embodiments, the metals include light metals. In some embodiments, the light metals include, without limitation, magnesium, lithium, and combinations thereof.

In some embodiments, the metals include heavy metals. In some embodiments, the heavy metals include, without limitation, iron, cobalt, copper, manganese, molybdenum, zinc, mercury, plutonium, lead, vanadium, tungsten, cadmium, chromium, arsenic, nickel, tin, thallium, aluminum, beryllium, bismuth, thorium, uranium, osmium, gold and combinations thereof.

In some embodiments, the metals include actinides. In some embodiments, the actinides include, without limitation, actinium, thorium, protactinium, uranium, neptunium, plutonium, americium, curium, berkelium, californium, einsteinium, fermium, mendelevium, nobelium, lawrencium, and combinations thereof.

In some embodiments, the metals to be captured include rare earth metals. In some embodiments, the rare earth metals include, without limitation, scandium, yttrium, lanthanum, cerium, praseodymium, neodymium, promethium, samarium, europium, gadolinium, terbium, dysprosium, holmium, erbium, thulium, ytterbium, lutetium, and combinations thereof.

In some embodiments, the metals to be captured from water sources are in the form of metal cations. In some embodiments, the metals to be captured from water sources are in the form of metal anions, such as oxygen-containing metal anions.

Oxidatively Modified Carbons

The methods of the present disclosure may utilize various types of oxidatively modified carbons for capturing contaminants from water sources. In some embodiments, the oxidatively modified carbon includes an oxidized carbon source. In some embodiments, the carbon source includes, without limitation, coke, coal, anthracite, charcoal, asphaltenes, activated carbon, asphalt and combinations thereof. In some embodiments, the carbon source excludes graphenes. In some embodiments, the carbon source excludes graphites.

In some embodiments, the carbon source of the oxidatively modified carbon is coal. In some embodiments, the coal includes, without limitation, anthracite, bituminous coal, sub-bituminous coal, metamorphically altered bituminous coal, asphalt, asphaltenes, peat, lignite, steam coal, petrified oil, and combinations thereof.

In some embodiments, the oxidatively modified carbon includes oxidized coal. In some embodiments, the oxidatively modified carbon includes, without limitation, oxidized coal, oxidized charcoal, oxidized bituminous coal, oxidized coke, oxidized anthracite, and combinations thereof. In some embodiments, the oxidatively modified carbon excludes graphene oxide. In some embodiments, the oxidatively modified carbon excludes graphite oxide.

In more specific embodiments, the carbon source for the oxidatively modified carbon is coke. In some embodiments, the oxidized coke is made from pitch, the heavy fraction of crude oil. In some embodiments, the oxidized coke is made from bituminous coal.

In some embodiments, the oxidatively modified carbon is functionalized with a plurality of functional groups. In some embodiments, the functional groups include, without limitation, carboxyl groups, hydroxyl groups, esters, amides, thiols, carbonyl groups, aryl groups, epoxy groups, phenol groups, covalent sulfates, sulfones, amine groups, ether-based functional groups, polymers, and combinations thereof.

In some embodiments, the oxidatively modified carbon is functionalized with a plurality of polymers. In some embodiments, the polymers include, without limitation, polyethylene glycols, polyvinyl alcohols, poly(ethyleneimines), polyamines, polyesters, poly(acrylic acids), and combinations thereof.

The oxidatively modified carbons of the present disclosure may have various types of structures. For instance, in some embodiments, the oxidatively modified carbons have a three-dimensional structure. In some embodiments, the oxidatively modified carbons are free-standing. In some embodiments, the oxidatively modified carbons have a granular structure.

In some embodiments, the oxidatively modified carbons of the present disclosure have a porous structure. In some embodiments, the oxidatively modified carbons have a plurality of pores. In some embodiments, the pores have diameters ranging from about 250 μm to about 1 nm. In some embodiments, the pores have diameters that range from about 100 μm to about 100 nm, from about 100 μm to about 3 nm, or from about 10 μm to about 3 nm.

In some embodiments, the oxidatively modified carbons have a layered structure. In some embodiments, the layered structures have nano-sized and micro-sized openings between the layers. In some embodiments, the openings are in the form of pores. In some embodiments, the layers between the openings comprise from 1 to 500 graphene layers. In some embodiments, the layers between the openings comprise from 20 to 500 graphene layers. In some embodiments, the layers between the openings comprise from 10 to 200 graphene layers. In some embodiments, the layers between the openings comprise from 1 to 20 graphene layers.

In some embodiments, the oxidatively modified carbons of the present disclosure are in the form of particles. In some embodiments, the particles have diameters ranging from about 1 μm to about 5 mm. In some embodiments, the particles have diameters ranging from about 100 μm to about 5 mm. In some embodiments, the particles have diameters ranging from about 250 μm to about 800 μm. In some embodiments, the particles have diameters ranging from about 2 μm to about 100 μm. In some embodiments, the particles have diameters ranging from about 1 μm to about 50 μm.

In some embodiments, the oxidatively modified carbons of the present disclosure have surface areas that range from about 1 m²/g to about 500 m²/g. In some embodiments, the oxidatively modified carbons of the present disclosure have surface areas that range from about 20 m²/g to about 250 m²/g. In some embodiments, the oxidatively modified carbons of the present disclosure have surface areas that range from about 50 m²/g to about 200 m²/g. In more specific embodiments, the oxidatively modified carbons of the present disclosure have surface areas that range from about 54 m²/g to about 96 m²/g.

Applying Oxidatively Modified Carbons to Water Sources

Various amounts of oxidatively modified carbon may be applied to water sources. For instance, in some embodiments, oxidatively modified carbon may applied to water sources in amounts ranging from about 0.5 g to about 40 g per liter of water source.

Moreover, oxidatively modified carbons may be applied to water sources in various states. In some embodiments, the oxidatively modified carbon is applied to the water source in solid form. In some embodiments, the oxidatively modified carbon is applied to the water source in liquid form (e.g., as a dispersion in a liquid). In some embodiments, the oxidatively modified carbon is applied to the water source in solid and liquid forms.

Various methods may also be utilized to apply oxidatively modified carbons to water sources. In some embodiments, the oxidatively modified carbon is applied to the water source by dispersing the oxidatively modified carbon in the water source. In some embodiments, the sorption occurs by mixing or swirling the oxidatively modified carbons in the water source for a certain amount of time (e.g., 10 minutes to 60 minutes). In some embodiments, the sorption occurs by keeping the oxidatively modified carbons in the water for a certain amount of time (e.g., 24 hours). In more specific embodiments, the oxidatively modified carbon that is dispersed in the water source is in the form of solid particles with diameters that range from about 10 μm to about 200 μm. Additional methods of dispersing oxidatively modified carbons in water sources can also be envisioned.

In some embodiments, the oxidatively modified carbon is applied to the water source by flowing the water source through a structure housing the oxidatively modified carbon. In some embodiments, the water source is repeatedly flowed through a structure housing the oxidatively modified carbon so as to remove more of the contaminants from the water source with each pass.

In some embodiments, the structure is a column. In some embodiments, the structure is a cartridge. In more specific embodiments, a solid form of oxidatively modified carbon can be used as an absorbing filler (e.g., individually or in combination with other components) in a sorption column to remove contaminants from a water source that flows through the column. In further embodiments, the oxidatively modified carbon that is loaded onto a column is in the form of solid particles with diameters that range from about 10 μm to about 5 mm.

In some embodiments, a cross-flow (also referred to as a tangential flow) filtering system is used to capture contaminants from a water source. In some embodiments, oxidatively modified carbon remains inside a cross-flow filtering system with captured contaminants (e.g., metals and radionuclides) while the purified water passes through the cross-flow filtering system.

In additional embodiments, the structure housing the oxidatively modified carbon is a filter. In more specific embodiments, the filter is a cross-flow filter or a tangential flow filtering system. In some embodiments, contaminants are removed from a water source by flowing the water source through the filter containing the oxidatively modified carbon.

In some embodiments, the oxidatively modified carbon is applied to the water source while the oxidatively modified carbon is compartmentalized. In more specific embodiments, the oxidatively modified carbon is applied to the water source while the oxidatively modified carbon is compartmentalized in a porous container. In some embodiments, the porous container may be composed of porous polymers (e.g., natural and synthetic polymers), filter paper, silk, plastics, nylons, ceramics, porous steel, and combinations thereof. In some embodiments, the porous containers may contain porous hydrophilic plastics. In some embodiments, the porous containers may be in the form of a porous bag that resembles a tea bag or sock-like structure. In some embodiments, the porous containers are made from regenerated cellulose, cellulose esters, polyethersulfone (PES), etched polycarbonate, collagen, and combinations thereof. In some embodiments, the oxidatively modified carbon is compartmentalized in a cross-flow filtering system.

In some embodiments, the porous container that contains oxidatively modified carbons is submerged into a contaminated water source. Thereafter, contaminants may be captured by the oxidatively modified carbons from the water source through osmosis from the water source into the interior of the porous container. In some embodiments, agitation of the porous container can increase the rate of the capture of the contaminants by the oxidatively modified carbons inside the porous container.

Capture of Contaminants by Oxidatively Modified Carbons

Contaminants may be captured by oxidatively modified carbons in various manners. For instance, in some embodiments, contaminants may be captured by oxidatively modified carbons through sorption. In some embodiments, the sorption includes absorption of the contaminants to the oxidatively modified carbon. In some embodiments, the sorption includes adsorption of the contaminants to the oxidatively modified carbon. In some embodiments, the sorption includes adsorption and absorption of the contaminants to the oxidatively modified carbon. In some embodiments, the sorption includes an ionic interaction between the contaminants and the oxidatively modified carbon.

Various amounts of contaminants may be captured by oxidatively modified carbons. For instance, in some embodiments, the sorption of contaminants by the oxidatively modified carbons results in the capture of at least about 50% of the contaminants in the water source. In some embodiments, the sorption of contaminants by the oxidatively modified carbons results in the capture of at least about 60% of the contaminants in the water source. In some embodiments, the sorption of contaminants by the oxidatively modified carbons results in the capture of at least about 75% of the contaminants in the water source. In some embodiments, the sorption of contaminants by the oxidatively modified carbons results in the capture of at least about 80% of the contaminants in the water source. In some embodiments, the sorption of contaminants by the oxidatively modified carbons results in the capture of at least about 85% of the contaminants in the water source. In some embodiments, the sorption of contaminants by the oxidatively modified carbons results in the capture of at least about 90% of the contaminants in the water source. In some embodiments, the sorption of contaminants by the oxidatively modified carbons results in the capture of at least about 99% of the contaminants in the water source. In some embodiments, the percentage of the captured contaminants in the water source represents the weight percentage of the total amount of radionuclides and metals in the water source.

Separation of Oxidatively Modified Carbons from Water Sources

In some embodiments, the methods of the present disclosure also include a step of separating the oxidatively modified carbon from the water source. In some embodiments, the separating occurs after the applying step. In some embodiments, the separating occurs after sorption of the contaminants in the water source to the oxidatively modified carbon.

Various methods may be utilized to separate oxidatively modified carbon from water sources. In some embodiments, the separating occurs by decanting, centrifugation, ultra-centrifugation, filtration, ultra-filtration, precipitation, electrophoresis, reverse osmosis, sedimentation, incubation, treatment of the water source with acids, treatment of the water source with bases, treatment of the water source with coagulants and chelating agents, and combinations thereof. In more specific embodiments, separation occurs by decanting, filtration, or centrifugation.

In some embodiments, the separating step includes addition of a coagulant or a polymer to the water source. In some embodiments, the coagulant or polymer addition leads to a precipitation of the oxidatively modified carbons from the water source. Thereafter, a step of decanting, filtration or centrifugation can separate the water source from the precipitated oxidatively modified carbon.

Reuse of Oxidatively Modified Carbons

In some embodiments, the oxidatively modified carbons may be reused after the capture of contaminants from a water source. In some embodiments, the oxidatively modified carbons may be regenerated prior to reuse in capturing contaminants from a water source. In some embodiments, the oxidatively modified carbons are regenerated by treatment with acid. Without being bound by theory, it is envisioned that treatment of oxidatively modified carbons with acid can release the trapped metals.

In some embodiments, oxidatively modified carbons may be regenerated by adjusting the pH value of the solution that contains the oxidatively modified carbons. For instance, in some embodiments, various contaminants may be captured at a first pH value (e.g., a pH value greater than 7) and released at a second pH value (e.g., a pH value of less than 7).

Methods of Preparing Oxidatively Modified Carbon

In some embodiments, the present disclosure pertains to methods of preparing oxidatively modified carbons. In some embodiments, the preparing occurs by oxidizing a carbon source. In some embodiments, the oxidizing occurs by exposing the carbon source to an oxidant. Various carbon sources, oxidants and oxidizing methods may be utilized to prepare oxidatively modified carbons.

Carbon Sources

In some embodiments, the carbon source used to prepare oxidatively modified carbons includes, without limitation, coke, coal, charcoal, asphalt, asphaltenes, activated carbon, and combinations thereof. In some embodiments, the carbon source is coal. In some embodiments, the coal includes, without limitation, anthracite, bituminous coal, sub-bituminous coal, metamorphically altered bituminous coal, asphalt, asphaltenes, peat, lignite, steam coal, petrified oil, and combinations thereof.

In some embodiments, the carbon source is coke. In some embodiments, the coke is made from pitch. In some embodiments, the coke is made from bituminous coals. In some embodiments, the coke is made from pitch and bituminous coals.

In some embodiments, the carbon source is ground into small particles prior to oxidizing. In some embodiments, the carbon source is ground into small particles by milling.

Oxidants

Various oxidants may be utilized to form oxidatively modified carbons. In some embodiments, the oxidant includes one or more compounds that are capable of oxidizing a carbon source, either individually or in combination. In some embodiments, the oxidant is in the form of a liquid medium. In some embodiments, the oxidant includes an anion. In some embodiments, the oxidant includes, without limitation, permanganates (e.g., potassium permanganate, sodium permanganate, and ammonium permanganate), chlorates (e.g., sodium chlorates and potassium chlorates), perchlorates, hypochlorites (e.g., potassium hypochlorites and sodium hypochlorites), hypobromites, hypoiodites, chromates, dichromates, nitrates, nitric acid, sulfuric acid, chlorosulfonic acid, oleum (i.e., sulfuric acid with dissolved sulfur trioxide), and combinations thereof. In more specific embodiments, the oxidant includes, without limitation, potassium permanganate, potassium chlorate, hydrogen peroxide, ozone, nitric acid, sulfuric acid, oleum, chorosulfonic acid, and combinations thereof.

In more specific embodiments, the oxidant includes a compound that is dissolved in an acid. In some embodiments, the compound includes, without limitation, permanganates (e.g., potassium permanganate, sodium permanganate, and ammonium permanganate), chlorates (e.g., sodium chlorates and potassium chlorates), perchlorates, hypochlorites, hypobromites, hypoiodites, chromates, dichromates, nitrates, nitric acid, peroxides (e.g., hydrogen peroxide), ozone, and combinations of thereof. In some embodiments, the acid includes, without limitation, sulfuric acid, nitric acid, oleum, chorosulfonic acid, and combinations thereof.

In more specific embodiments, the compound includes at least one of potassium permanganate, sodium hypochlorite, potassium hypochlorite, potassium chlorate, nitric acid, and combinations thereof. In additional embodiments, the compound is dissolved in sulfuric acid.

In further embodiments, the oxidant is potassium permanganate dissolved in sulfuric acid (also referred to as KMnO₄/H₂SO₄). In some embodiments, the oxidant is nitric acid dissolved in sulfuric acid (also referred to as HNO₃/H₂SO₄).

Oxidation of Carbon Sources

Various methods may be utilized to oxidize carbon sources to form oxidatively modified carbons. In some embodiments, the oxidizing occurs by exposing the carbon source to an oxidant. In some embodiments, the exposing occurs by sonicating the carbon source in a solution that contains the oxidant. In some embodiments, the exposing includes stirring the carbon source in a solution that contains the oxidant. In some embodiments, the exposing includes heating the carbon source in a solution that contains the oxidant. In some embodiments, the heating occurs at temperatures of at least about 100° C. In some embodiments, the heating occurs at temperatures ranging from about 100° C. to about 150° C. Additional methods of exposing carbon sources to oxidants can also be envisioned.

Post-Reaction Steps

In some embodiments, the formed oxidatively modified carbon material is separated from the oxidant. In some embodiments, the separation occurs by at least one of decanting, filtration, or centrifugation. In some embodiments, the separated sulfuric acid can be reused to prepare more oxidatively modified carbons (i.e., recycled). In some embodiments, the reaction media and the oxidant can be recycled. In some embodiments, the separation of the oxidatively modified carbon from the oxidant occurs by quenching the reaction with water, or with an ice-water mixture to speed up the separation of the oxidized carbon from the solution (e.g., sulfuric acid).

In some embodiments, the formed oxidatively modified carbon material can also be dried. In some embodiments, the oxidatively modified carbon material is dried under ambient conditions. In some embodiments, the oxidatively modified carbon material can be dried at slightly elevated temperatures (60° C.) and reduced pressure in order to increase the product's sorption capacity.

Materials for Capturing Contaminants from a Water Source

Further embodiments of the present disclosure pertain to materials for capturing contaminants from a water source. In some embodiments, the materials include an oxidatively modified carbon that includes an oxidized carbon source. In some embodiments, the oxidatively modified carbon is made by the aforementioned methods of the present disclosure. In some embodiments, the oxidized carbon source is derived from a carbon source that includes at least one of coke, coal, charcoal, asphalt, asphaltenes, activated carbon, and combinations thereof. In some embodiments, the carbon source is coal. In some embodiments, the coal includes, without limitation, anthracite, bituminous coal, sub-bituminous coal, metamorphically altered bituminous coal, asphalt, asphaltenes, peat, lignite, steam coal, petrified oil, and combinations thereof. In some embodiments, the carbon source excludes graphites.

In some embodiments, the oxidatively modified carbon includes oxidized coke. In further embodiments, the oxidatively modified carbon includes, without limitation, oxidized coal, oxidized charcoal, oxidized bituminous coal, oxidized coke, oxidized anthracite, and combinations thereof. In some embodiments, the oxidatively modified carbon excludes graphene oxide. In some embodiments, the oxidatively modified carbon excludes graphite oxide.

In some embodiments, the oxidatively modified carbon is functionalized with a plurality of functional groups. In some embodiments, the functional groups include, without limitation, carboxyl groups, hydroxyl groups, esters, amides, thiols, carbonyl groups, aryl groups, epoxy groups, phenol groups, covalent sulfates, sulfones, amine groups, ether-based functional groups, polymers, and combinations thereof.

In some embodiments, the oxidatively modified carbon is functionalized with a plurality of polymers. In some embodiments, the polymers include, without limitation, polyethylene glycols, polyvinyl alcohols, poly(ethyleneimines), polyamines, polyesters, poly(acrylic acids), and combinations thereof.

In some embodiments, the oxidatively modified carbons have a three-dimensional structure. In some embodiments, the oxidatively modified carbons are free-standing. In some embodiments, the oxidatively modified carbons have a granular structure. In some embodiments, the oxidatively modified carbons have a porous structure. In some embodiments, the oxidatively modified carbons are in the form of particles. In some embodiments, the particles have diameters ranging from about 1 μm to about 5 mm. In some embodiments, the particles have diameters ranging from about 100 μm to about 5 mm. In some embodiments, the particles have diameters ranging from about 250 μm to about 800 μm. In some embodiments, the particles have diameters ranging from about 2 μm to about 100 μm. In some embodiments, the particles have diameters ranging from about 1 μm to about 50 μm.

In some embodiments, the oxidatively modified carbons of the present disclosure have surface areas that range from about 10 m²/g to about 500 m²/g. In some embodiments, the oxidatively modified carbons of the present disclosure have surface areas that range from about 20 m²/g to about 250 m²/g. In some embodiments, the oxidatively modified carbons of the present disclosure have surface areas that range from about 50 m²/g to about 100 m²/g. In more specific embodiments, the oxidatively modified carbons of the present disclosure have surface areas that range from about 54 m²/g to about 96 m²/g.

In some embodiments, the oxidatively modified carbons of the present disclosure have a porous structure. In some embodiments, the oxidatively modified carbons have a plurality of pores. In some embodiments, the pores have diameters ranging from about 250 μm to about 1 nm. In some embodiments, the pores have diameters that range from about 100 μm to about 100 nm, from about 100 μm to about 3 nm, or from about 10 μm to about 3 nm.

In some embodiments, the oxidatively modified carbons have a layered structure. In some embodiments, the layered structures have nano-sized and micro-sized openings between the layers. In some embodiments, the openings are in the form of pores. In some embodiments, the layers between the openings comprise from 1 to 500 graphene layers. In some embodiments, the layers between the openings comprise from 20 to 500 graphene layers. In some embodiments, the layers between the openings comprise from 10 to 200 graphene layers. In some embodiments, the layers between the openings comprise from 1 to 20 graphene layers.

Applications and Advantages

Applicants have shown that oxidatively modified carbons can be used to capture various contaminants from water sources. Furthermore, in some embodiments, the three-dimensional and granular structure of the oxidatively modified carbons of the present disclosure eliminates any requirement of additional structural support. Moreover, the oxidatively modified carbons of the present disclosure can be used in traditional absorption columns, or be dispersed and collected from water sources. In the latter case, oxidatively modified carbons can be easily separated from water by self-sedimentation within a short period of time and following decanting.

Moreover, the oxidatively modified carbons of the present disclosure provide a cost effective alternative to capturing contaminants from water sources. For instance, the cost of many oxidants and carbon sources utilized to make oxidatively modified carbons (e.g., KMnO₄/H₂SO₄ and coke, respectively) are significantly lower when compared to the cost of graphite. In a more specific example, the costs of making oxidized coke can be ten times cheaper than the costs of making GO.

Furthermore, less material may be used to make the oxidatively modified carbons of the present disclosure. For instance, in some embodiments, far less acid is used to make oxidized coke than to make GO. In particular, only 0.5-2.0 weight equivalents of KMnO₄ may be utilized in some embodiments to make oxidized coke. On the other hand, 4 weight equivalents of KMnO₄ may be needed to make GO.

Moreover, the contaminants captured by the oxidatively modified carbons of the present disclosure can be managed in an efficient manner. For instance, upon capture, the carbon materials can be burned or incinerated to leave contaminants (e.g., metal ions or metal oxides) in a condensed state. In particular, the oxidatively modified carbons can be converted to CO₂, CO and H₂O upon incineration. In such instances, the remaining contaminants (e.g., metal ions or metal oxides) may be in the form of ashes or condensed materials that could be readily recycled, condensed, or buried.

Accordingly, the methods and compositions of the present disclosure can have various applications. For instance, in some embodiments, the oxidatively modified carbons can be used to effectively clean a water source from radionuclides and metals. In some embodiments, the oxidatively modified carbons of the present disclosure can be used to extract metal cations (such as U) from ground waters. In more specific embodiments, the methods and oxidatively modified carbon sources of the present disclosure can be used to capture actinides from a water source that contains nuclear fission products.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Preparation of OMCs from Coke

This Example illustrates a method of preparing about 10 g to 12 g of oxidatively modified carbon (OMC) by the oxidation of coke. First, coke is ground (e.g., by milling) to reach the granular size of 10 μm to 600 μm. Properly milled coke (10 g) is dispersed in 100 mL of concentrated sulfuric acid (96-98%) and swirled for 10 min. Potassium permanganate (KMnO₄) (15 g) is added to the slurry. The reaction time is 4-48 h. The end of the reaction is manifested by a change of the original green color of the reaction mixture to pinkish-brown.

Next, the reaction mixture is centrifuged to separate as-prepared OMC from sulfuric acid. Alternatively, the reaction mixture can simply stay 24-48 hours to achieve self-precipitation of OMC. Sulfuric acid is separated by decanting. The separated sulfuric acid can be reused to prepare the next batch of OMC.

The OMC precipitate is then dispersed in a new portion of water. Next, 3 mL of 30% H₂O₂ is added to the mixture to convert insoluble MnO₂ by-products to soluble manganese(II) sulfates (MnSO₄). The OMC is washed with DI water several times to remove sulfuric acid and inorganic by-products (such as K₂SO₄ and MnSO₄). The formation and modification of surface functional groups continues during the washing procedures due to chemical interactions of oxidized carbon with water. The washed and as-modified OMC is dried under ambient conditions. The above mentioned procedures yield 12 g of dry OMC. The OMC can also be re-dispersed in a fresh portion of deionized water and re-used as a dispersion.

Alternatively, a mixture of nitric acid and sulfuric acid (30 mL: 90 mL) can be used for the oxidation of coke instead of KMnO₄/H₂SO₄. Under this protocol, the coke is milled to achieve particle sizes from 10 μm to 0.5 mm. Properly milled coke (e.g., 10 g) is dispersed in 90 mL of concentrated sulfuric acid (96-98%) and swirled for 10 min. Commercial concentrated (65-70%) nitric acid (20-30 mL) is added to the mixture and swirled for 4-24 h. The reaction mixture is centrifuged to separate OMC from the nitric acid-sulfuric acid mixture. The separated acidic mixture can be reused to prepare the next batch of OMC after regeneration. Regeneration can be accomplished by means of electrolysis, which converts reduced form of nitrogen back to N(+5). Alternatively regeneration can be accomplished by addition of small portions of new nitric acid and sulfuric acid. The OMC precipitate is washed with water several times to remove sulfuric acid and nitric acid. The formation and modification of surface functional groups continues during the washing procedures due to the chemical interaction of oxidized carbon with water. The washed and as-modified OMC is dried under ambient conditions.

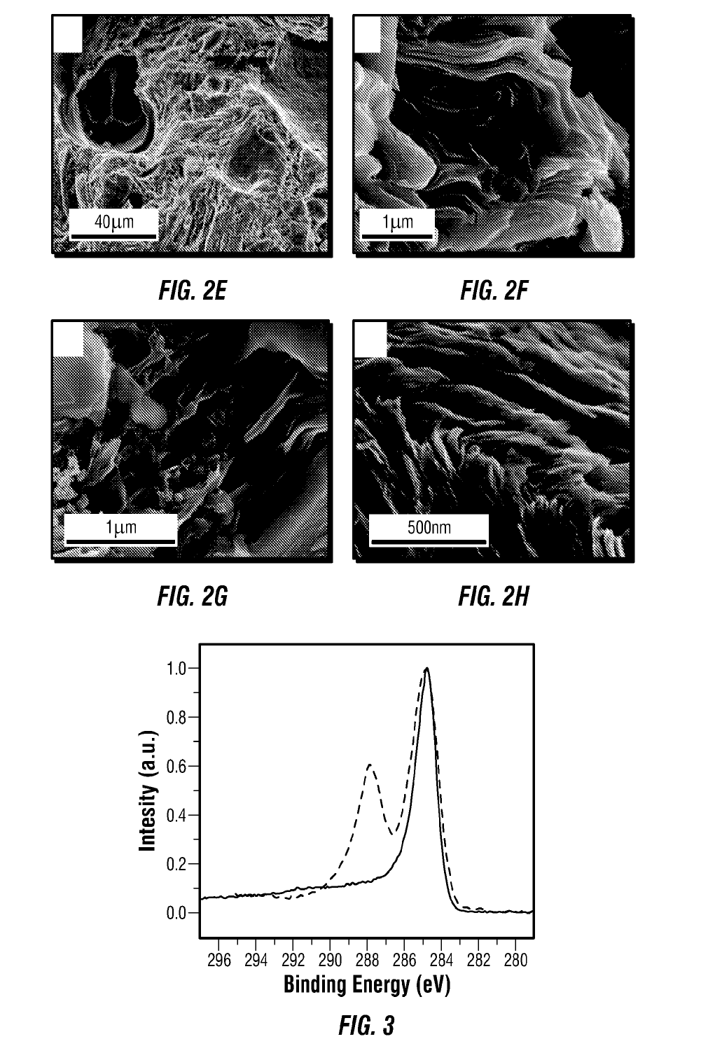

FIG. 2 shows scanning electron microscopy (SEM) images of OMCs prepared by the aforementioned methods at different magnifications. The SEM images in FIG. 2 show that the particulate structure of original coke is preserved. This makes OMC very different from lamellar graphite oxide produced by oxidation of graphite. As produced graphite oxide, being exposed to water, completely exfoliates to single atomic layer graphene oxide sheets. The resulted graphene oxide (GO)-in-water colloid solution is very stable and resistive to separation by centrifugation and especially by filtration. However, unlike two-dimensional graphene oxide, OMC retains its original three-dimensional granular structure. Therefore, OMC can be used in traditional sorption columns.

The higher magnification images of the OMC (FIGS. 2B-D) demonstrate that OMC is very porous. The pore size distribution is from several microns through hundreds of nanometers. The highly developed porous structure is additionally confirmed by BET data. The surface area for different OMC samples varied from 54 m²/g through 96 m²/g, which is very high for particulate materials. Such surface areas are slightly higher than that of original coke, which varied from 22 m²/g through 78 m²/g. This suggests that additional pores might be developed during the oxidative treatment. Without being bound by theory, it is envisioned that the highly porous OMC structure with broad pore size distribution is a factor for the OMC efficacy toward ion removal. For instance, the large size pores can afford mass liquid flow while the small size pores can afford osmotic ion migration.

FIG. 3 shows the C1s XPS spectra of OMCs in comparison to that for the original coke. The peak at 284.8 eV corresponds to elemental carbon. The peak at 288 eV corresponds to the carbon atoms covalently bonded to oxygen with formation of several functionalities. The intense 288 eV peak suggests that the OMC surface is heavily functionalized with oxygen. Thus, the surface of OMC is very different from the surface of original coke. In addition to the appearance of the 288 eV peak, the 284.8 eV peak broadens. This observation indicates that there is a significant change of the coke surface upon oxidation.

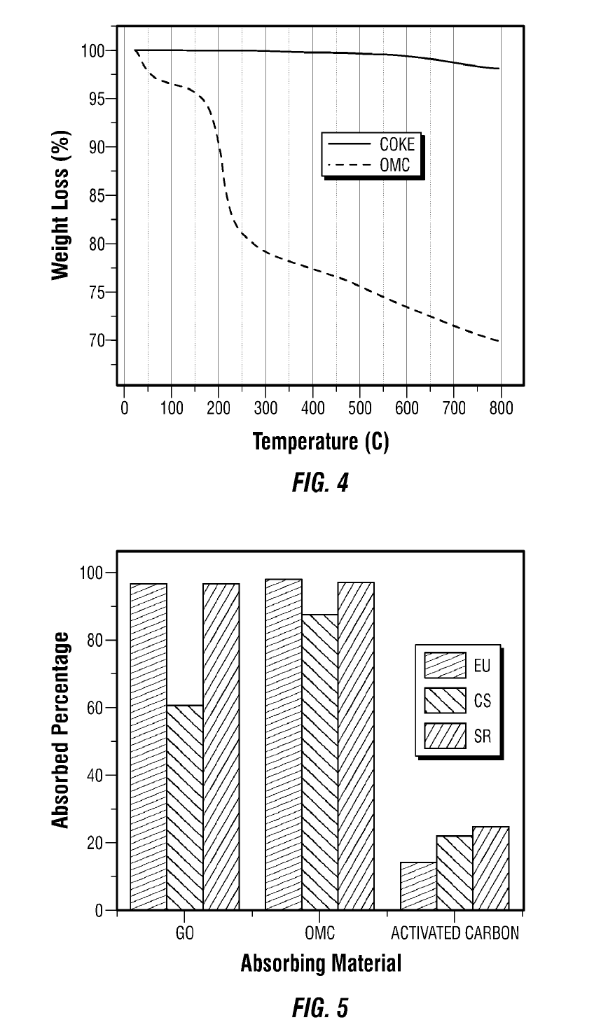

FIG. 4 provides thermogravimetric analysis (TGA) data of OMC in comparison to original coke. The original coke does not lose any weight up to 600° C., and loses only a few percent at temperatures above 600° C. Moreover, original coke does not contain any significant amounts of adsorbed water, since carbon is hydrophobic.

In contrast, the TGA curve for OMC resembles GO. OMC loses 3% of its weight as the temperature is raised between 22° C. and 70° C. Without being bound by theory, such weight loss is associated with adsorbed water. More significant weight loss of OMC occurs as the temperature is raised between 170° C. and 230° C. Without being bound by theory, such weight loss is associated with decomposition of the surface oxygen functional groups.

### Example 2

### Use of OMCs to Remove Radionuclides and Heavy Metals from Water

In this Example, the OMCs prepared by the methods outlined in Example 1 are used to remove radionuclides and heavy metals from water by the following techniques: (1) dispersing OMCs in contaminated water; (2) using OMCs as an absorbing filler in sorption columns; and (3) using OMCs in a bag (i.e., the “tea bag” technique).

### Example 2.1

### Dispersal of OMCs in Contaminated Water

In this Example, radionuclides and heavy metals are removed from a contaminated water source by dispersing OMCs in the water source, incubating the OMCs with the contaminants in the water source, and separating the contaminant-enriched OMCs from the water.

In this Example, the sizes of the OMC particles are in the range of 2 μm to 200 μm. The dry solid OMC (or its aqueous dispersion) is loaded into the contaminated water and swirled for 10 to 60 min. Alternatively, the dispersion of OMCs in purifying water can simply stay without agitation for 24 h. About 0.5 g to about 20 g of OMCs may be utilized to nearly completely remove radionuclides and heavy metals from 1 L of highly contaminated water. Next, the purified water is separated from OMCs by decanting, filtration, or centrifugation.

To compare the efficacy of OMCs with that of the known carbon-based absorbents (i.e., activated carbon and GO), the following experiment was conducted. 500 mg of GO, OMC and activated carbon were placed separately in 1 L of contaminated water. The original concentration of metal cations in the contaminated water was 5.0×10⁻⁷ mol/L for each of the following ions: Eu(III), Cs, and Sr. The metals were introduced in the form of their nitrates. After addition of absorbents, the solutions were stirred with a magnetic stirrer for 1 h.

Next, the absorbents were separated from the solution. OMC and activated carbon were separated by filtration. GO was separated by centrifugation. The solutions were analyzed for the content of the three metal cations.

FIG. 5 shows the efficacy of the three tested absorbents. The efficacy of both GO and OMC significantly exceeds that of activated carbon. Without being bound by theory, Applicants attribute this difference to high content of oxygen functional groups on the GO and OMC surface, which makes these two absorbents more effective toward metal cations. At the same time, the efficacy of OMC is similar to that of GO towards Eu and Sr.

Moreover, the OMC efficacy toward Cs is higher than that of GO. Such observations are significant because, theoretically, absorption of truly two-dimensional GO must be higher than that of three-dimensional OMC. Without being bound by theory, Applicants explain this observation by a possible non-complete removal of contaminant-enriched GO from water. Very small (nm-sized) GO flakes might remain in solution after centrifugation due to their high solubility in water.

### Example 2.2

### Using OMCs as an Absorbing Filler in Sorption Columns

As an alternative purifying technique, the solid OMC can be used as an absorbing filler (individual or in combination with other components) in traditional sorption columns. In this Example, the sizes of the OMC particles are in the range of 100 μm to 2 mm. In this Example, 10 g of OMC was used as the filler in an absorption column. The column diameter was 2 cm. 3 L of contaminated water passed through the column in five portions of 600 mL each. Each portion of water was collected and analyzed separately. The original concentration of the metal cations in the contaminated water was 5.0×10⁻⁷ mol/L for each of the following ions in the form of nitrates: Eu(III), Cs, and Sr.

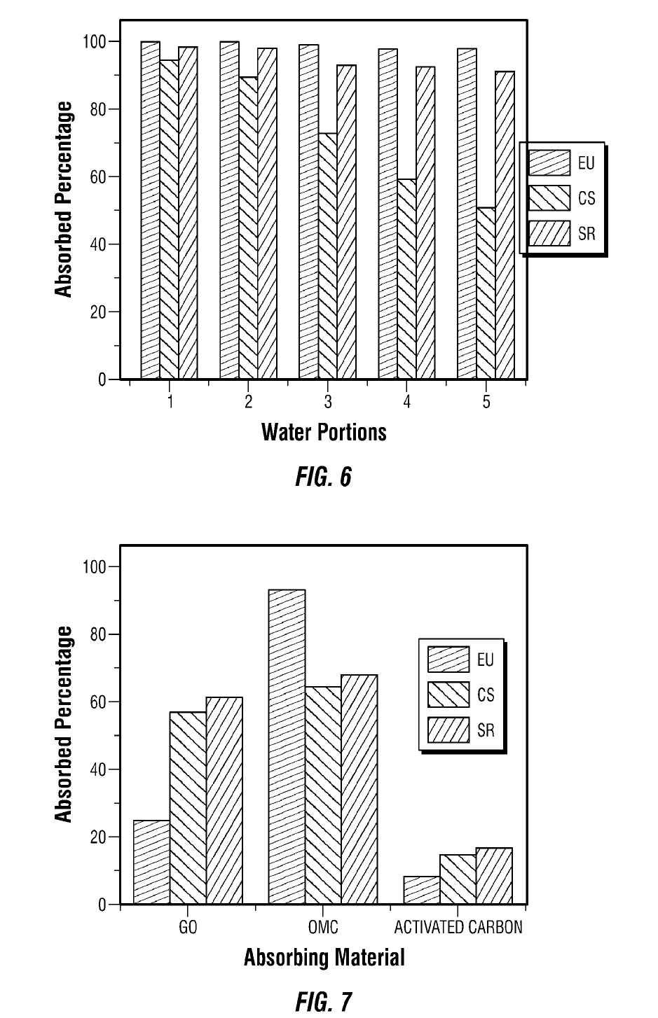

FIG. 6 shows the efficacy of the water purification. One can see that sorption efficacy gradually decreases with every new water portion. However, even for the fifth water portion, it still remains above 90% toward Eu and Sr, and above 50% toward Cs. In a control experiment with activated carbon, the cation removal was lower than 20% for all the three metal cations. Note that GO cannot be used in absorption columns due to its two-dimensional character and high solubility in water.

### Example 2.3

### Using OMCs in a Bag (i.e., the “Tea Bag” Technique)

In this Example, solid OMCs are placed inside bags made from permeable materials (e.g., papers, plastics, nylons, regenerated cellulose, cellulose ester, polyethersulfone (PES), etched polycarbonate, collagen, and the like). Next, the bags are submerged into a tank with contaminated water. The purification is then accomplished by osmosis or simple transport by migration of metal cations from bulk solution into the bags. Once inside the bags, the contaminants are absorbed by the OMCs inside the bags. Agitation of water in the tank will increase the rate of purification. These bags can also be inserted into the ground to prevent leaching of contaminated waters into or out of designated areas.

In the experiment described below, three different absorbents (OMC, GO and activated carbon) were compared. 1.0 g of OMC, GO and activated carbon were placed inside three different bags. Next, the bags were submerged separately into 1 L of contaminated water. The contaminated water contained 5.0×10⁻⁷ mol/L of each of Eu(III), Cs, and Sr in the form of nitrates. The solutions were slowly swirled with a magnetic stirrer for 24 h. Next, the bags with contaminant-enriched absorbents were removed from purified solutions. The solutions were then analyzed for metal cation content. FIG. 7 shows that the sorption efficacy of OMC exceeds those of activated carbon and GO. Without being bound by theory, Applicants attribute the lower absorbing capacity of activated carbon to its hydrophobic nature and lower content of oxygen functional groups. Applicants also envision that the lower efficacy of GO is due to the lower mobility of metal cations in the thick GO gel, which forms inside the tea bag after it is submerged into the water.

Based on the OMC efficacy in the three different purifying techniques outlined in Examples 2.1-2.3, OMC appears to be the most effective purifying material among the three materials tested.

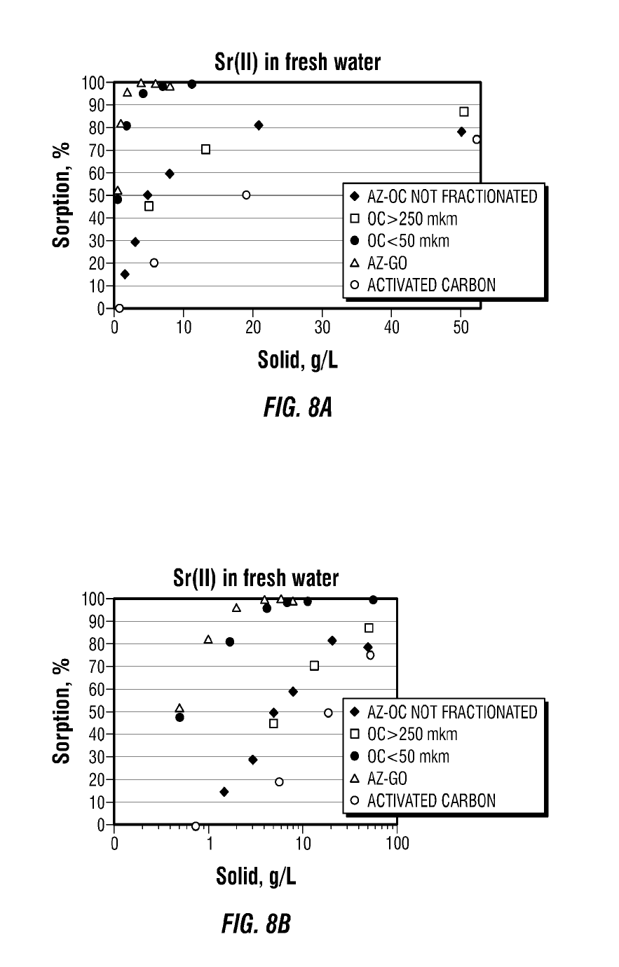

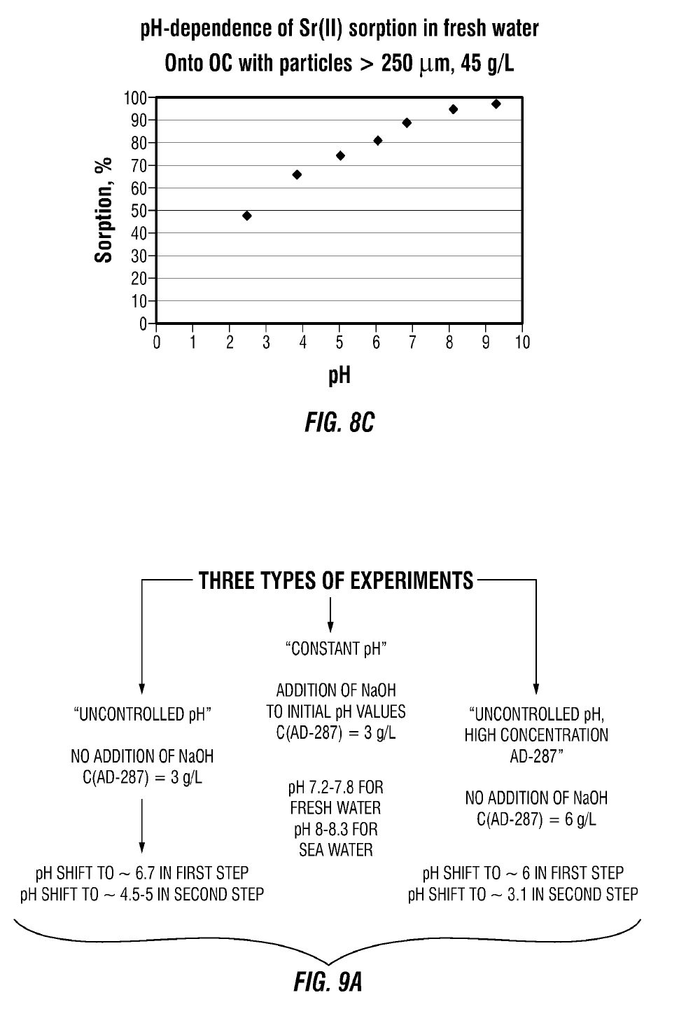

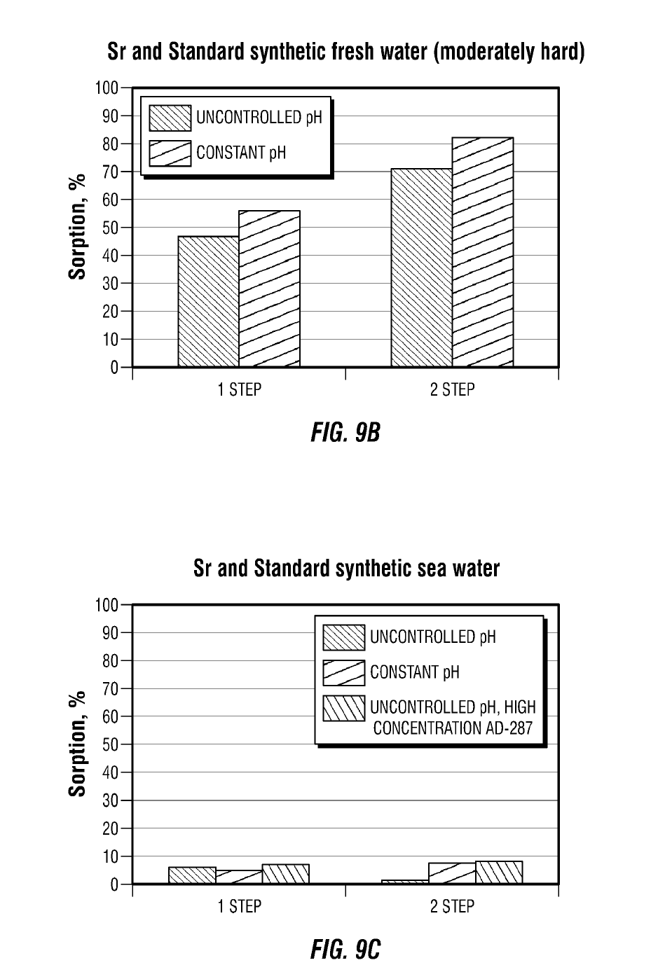

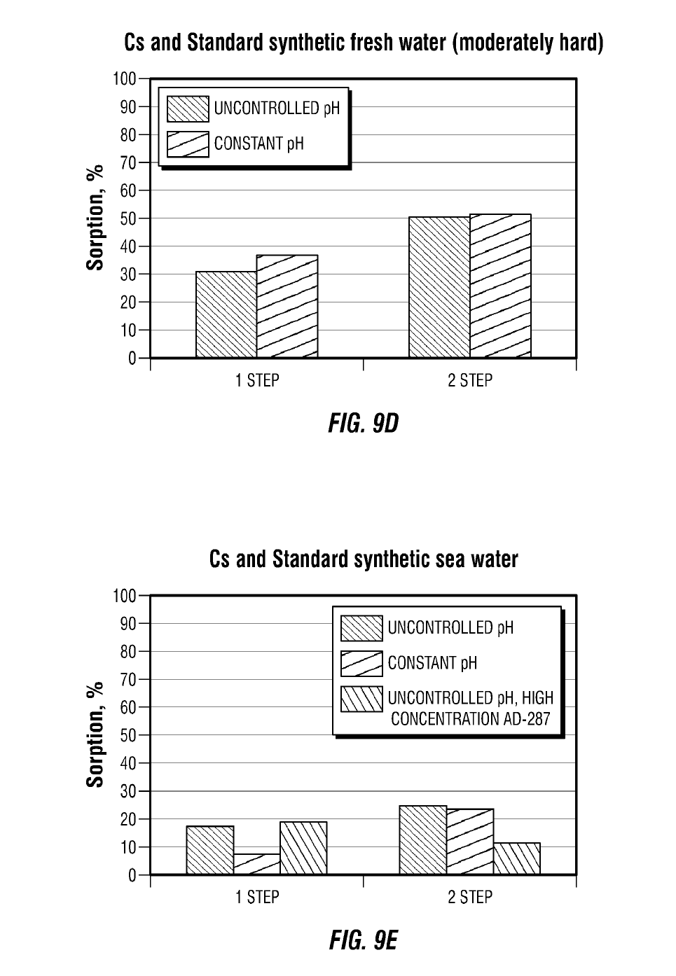

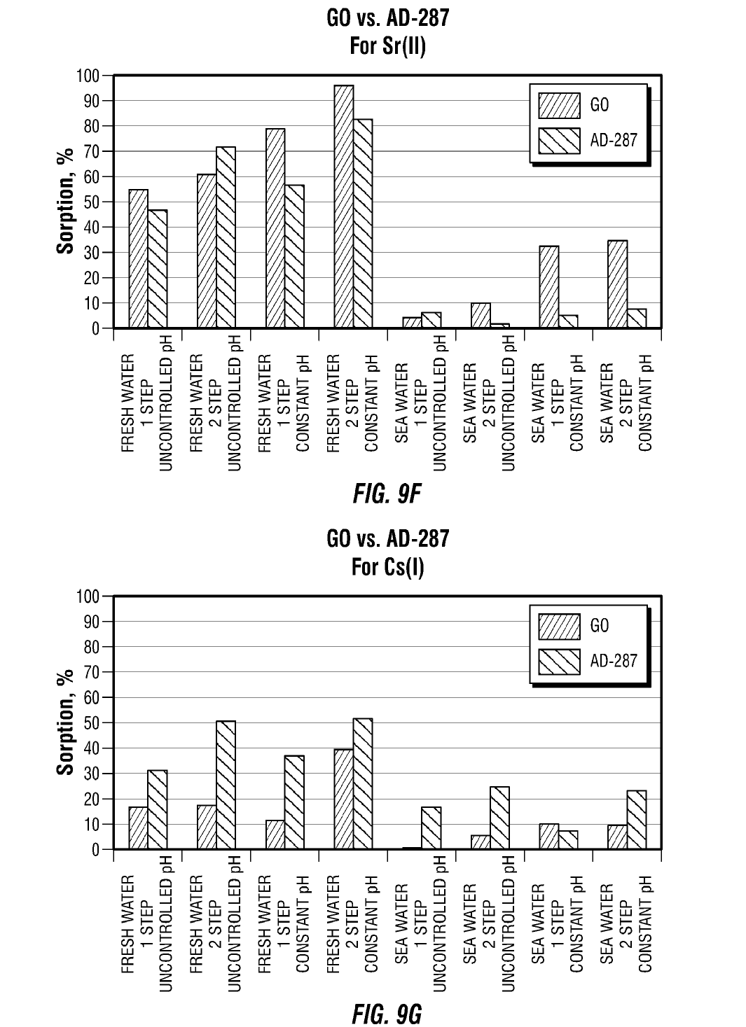

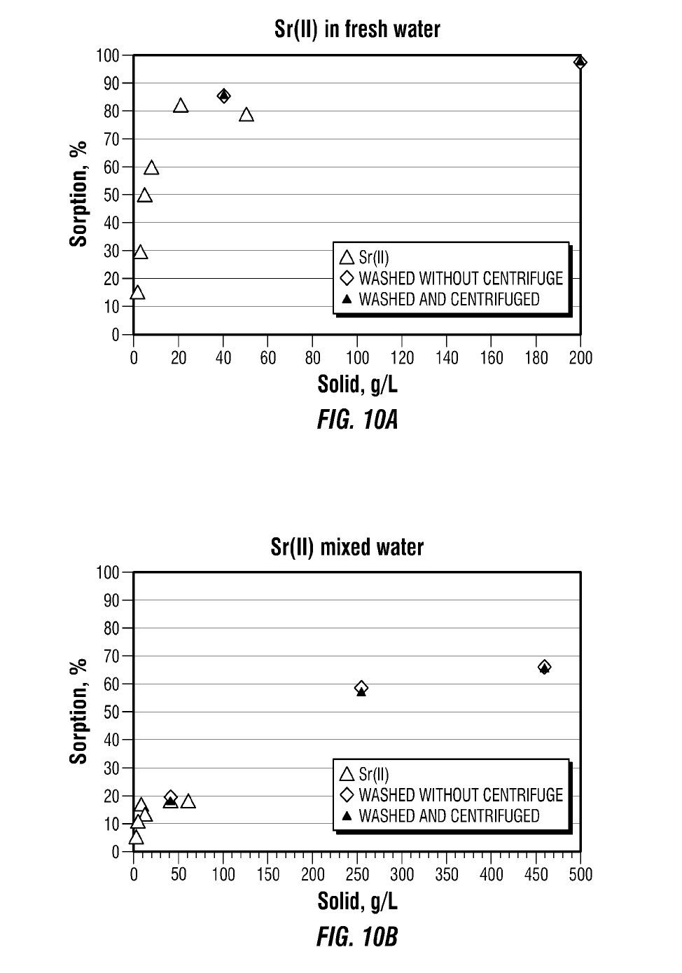

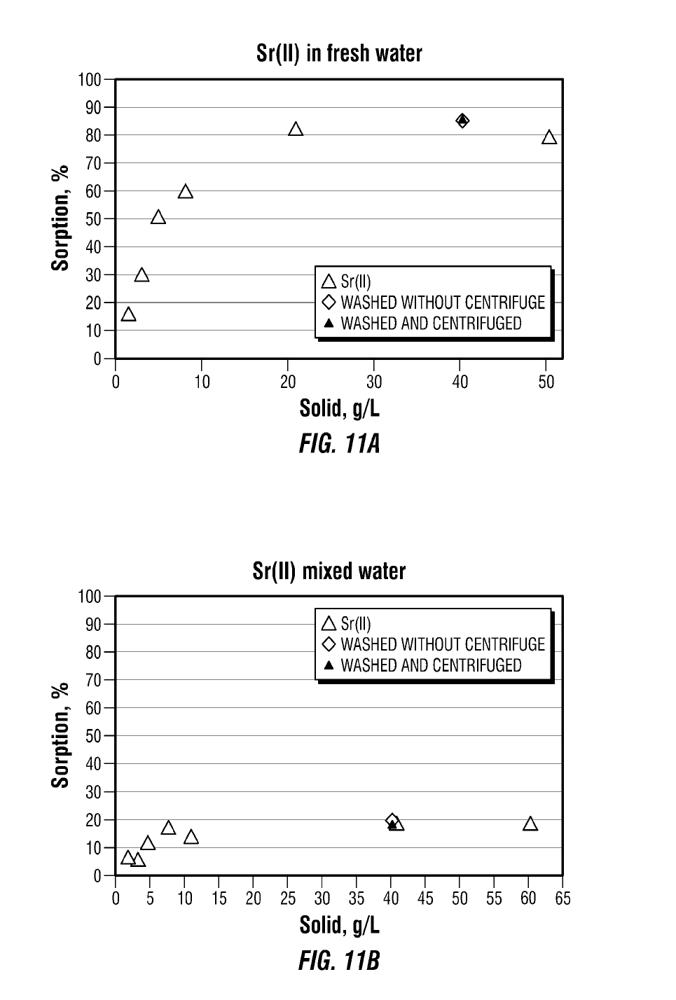

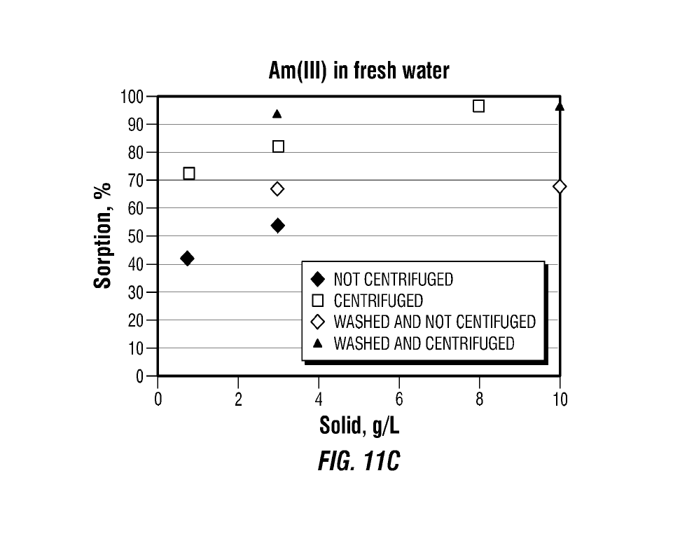

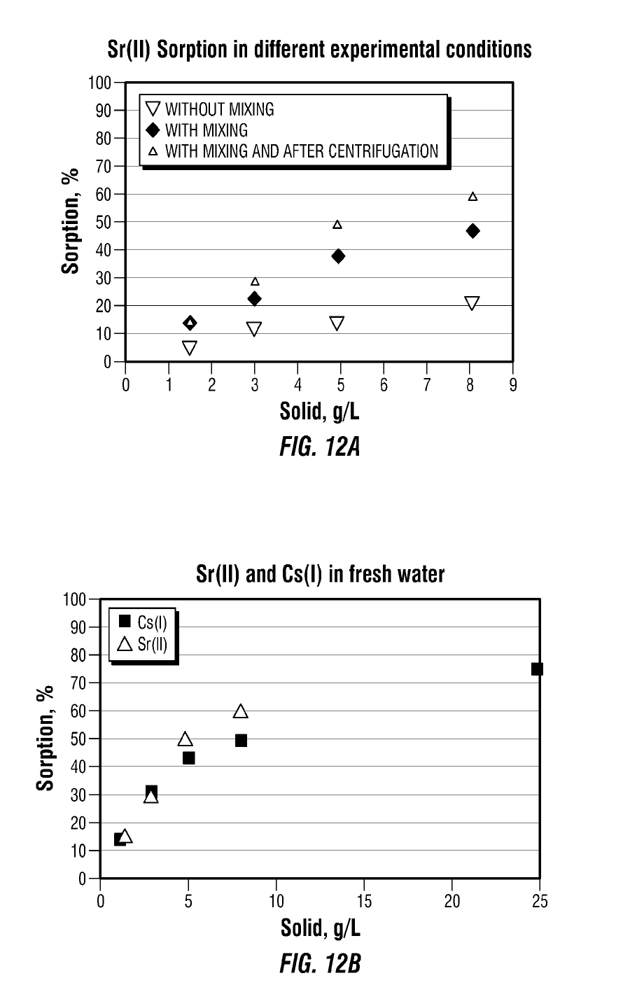

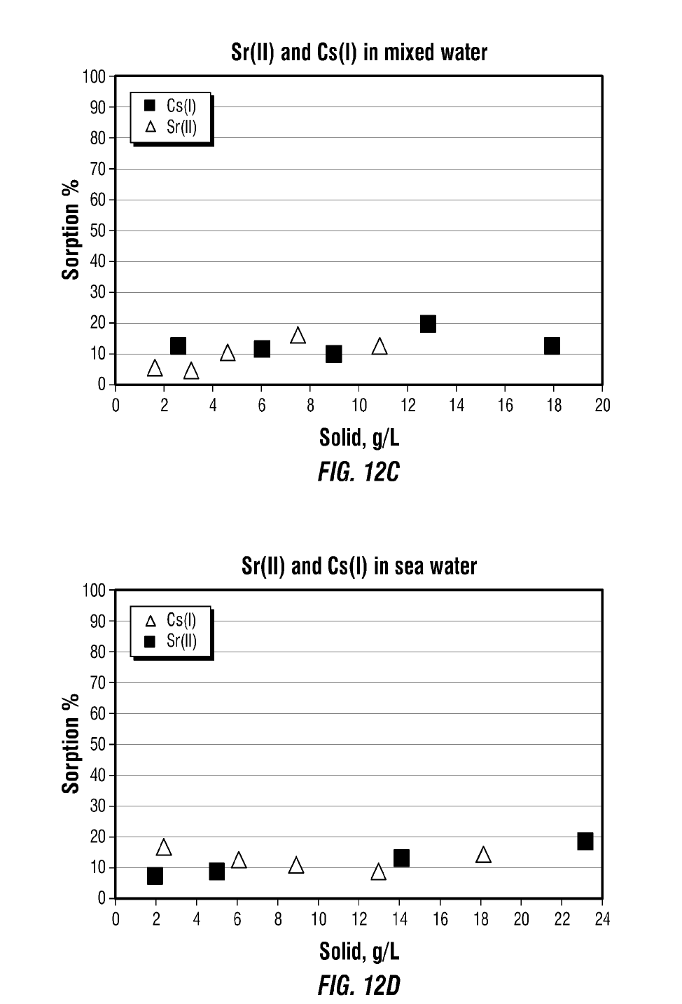

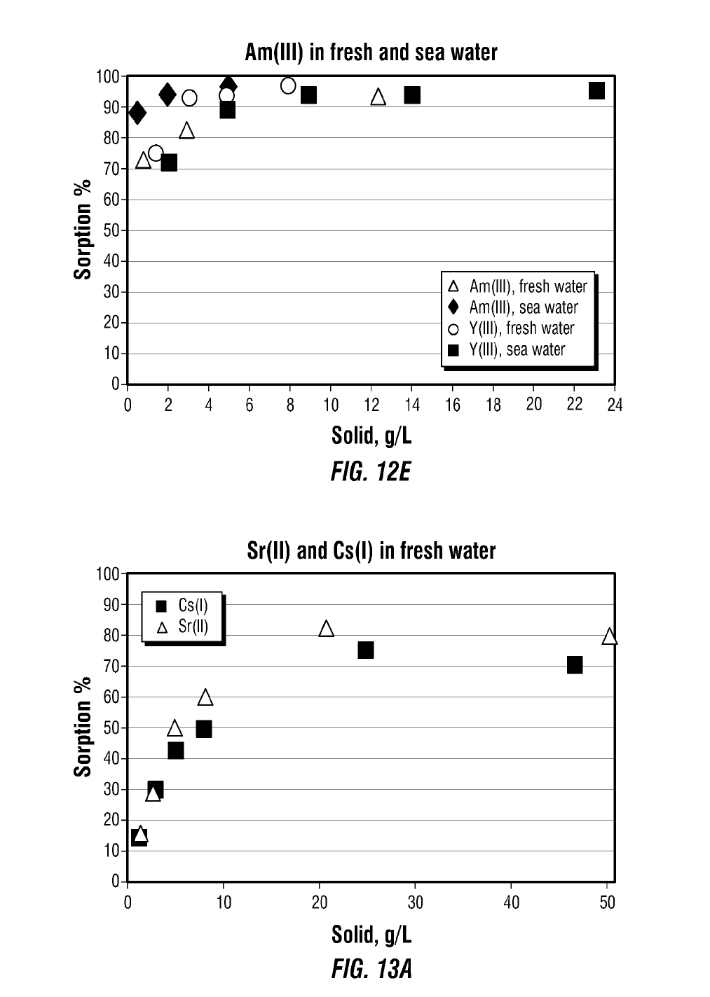

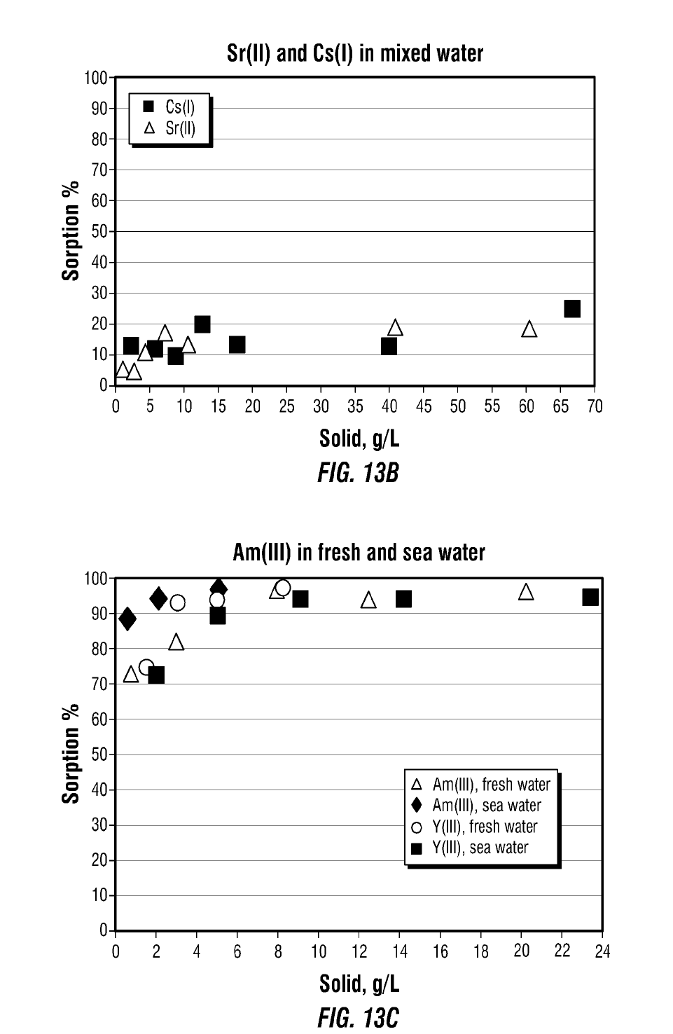

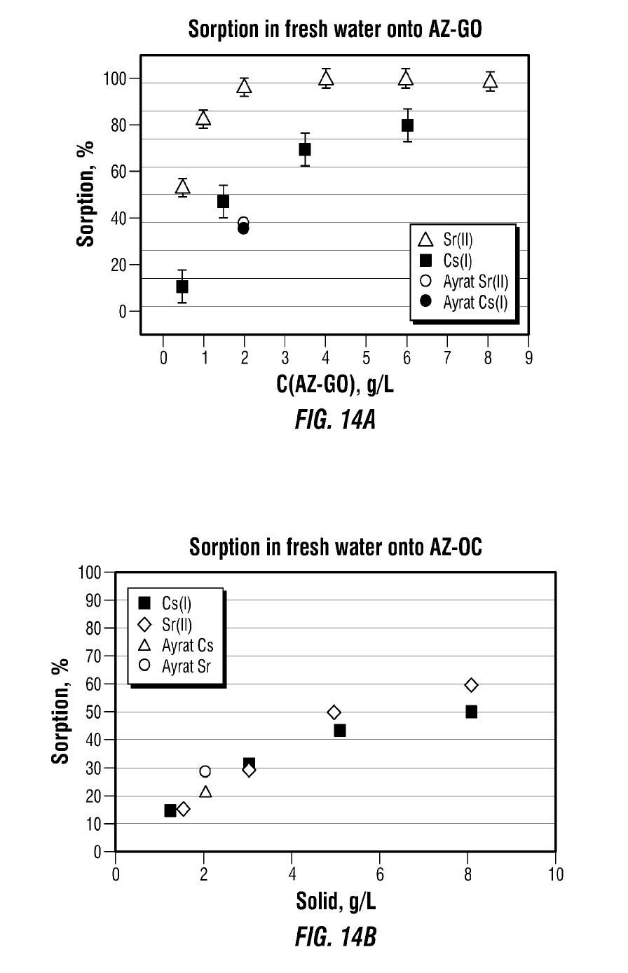

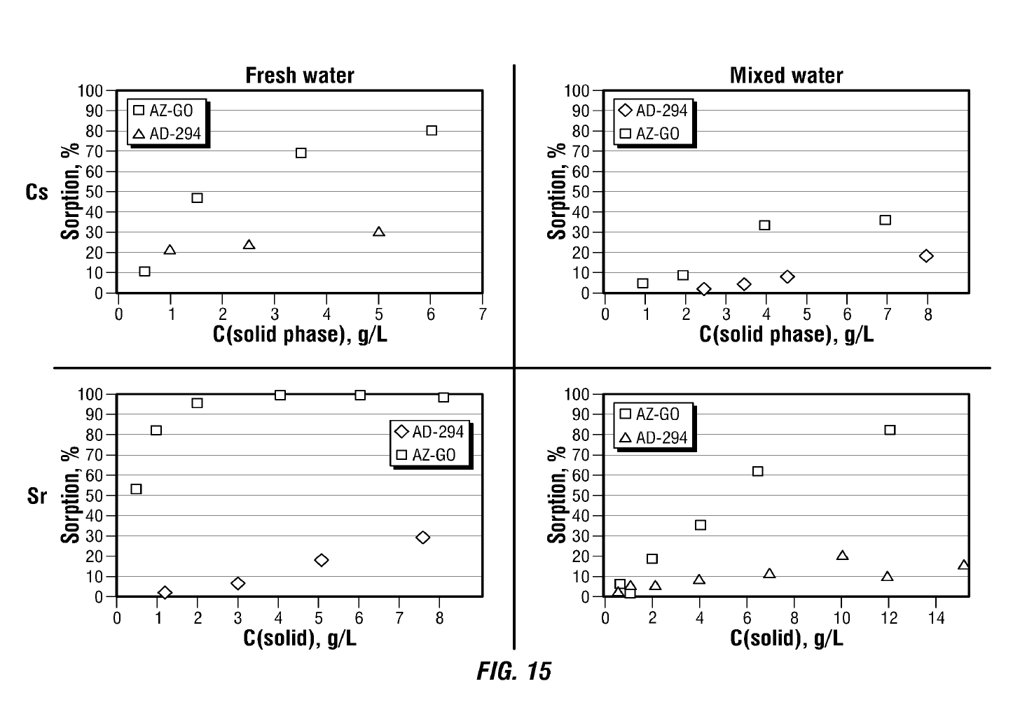

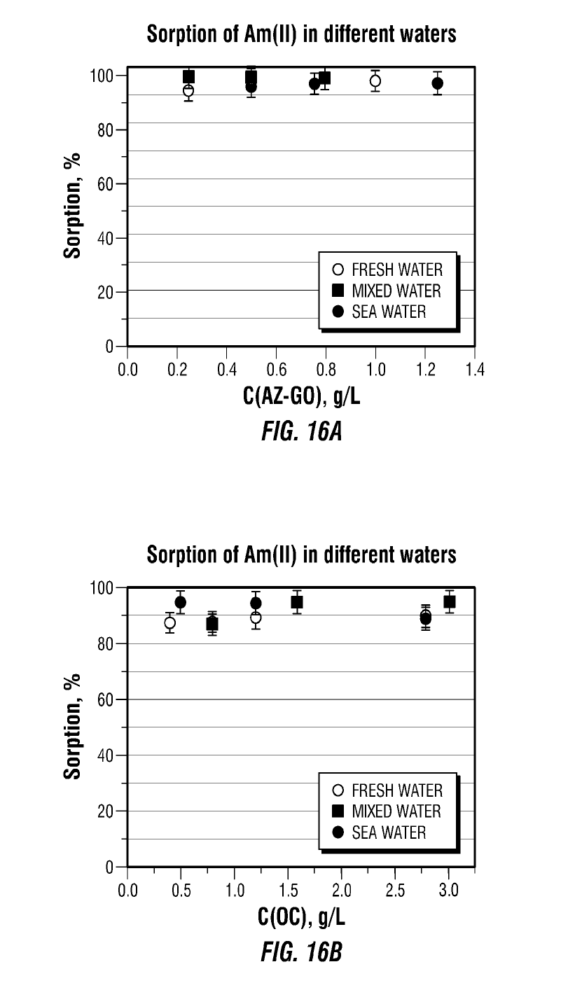

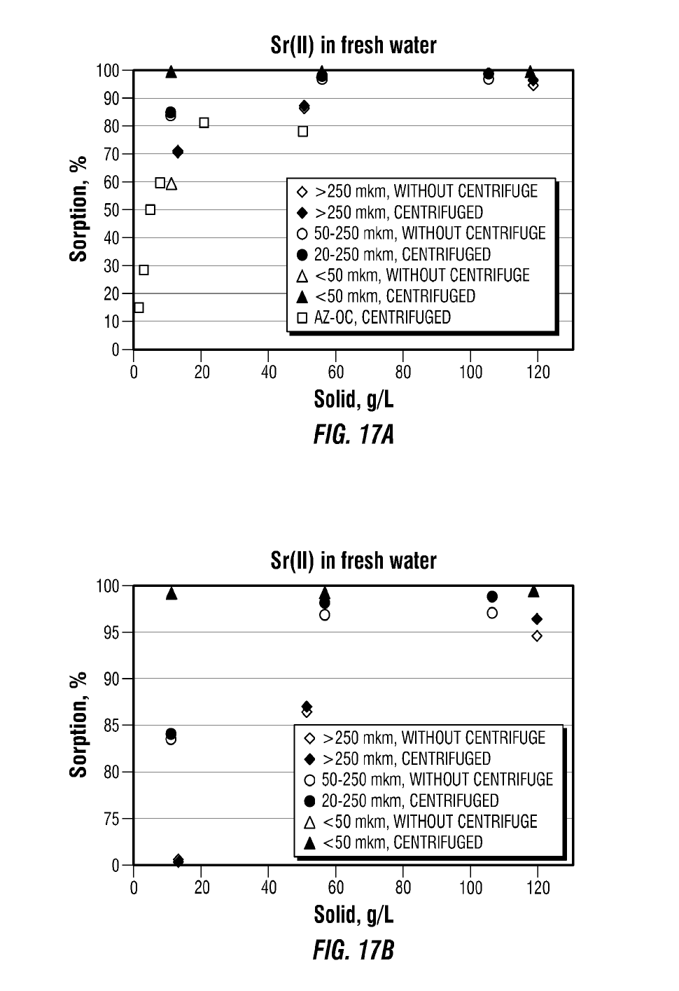

Additional data relating to the efficacies of OMCs in capturing radionuclides from water sources are shown in FIGS. 8-17. Though many of the data are preliminary, the data affirm that the OMCs are as effective as GOs in removing various radionuclides from various water sources under various conditions, including different pH levels.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of capturing contaminants from a water source, wherein the method comprises:
applying an oxidatively modified carbon to the water source,
wherein the applying leads to sorption of the contaminants in the water source to the oxidatively modified carbon, and
wherein the contaminants are selected from the group consisting of radionuclides, metals, and combinations thereof.

2. The method of claim 1, further comprising a step of separating the oxidatively modified carbon from the water source, wherein the separating occurs after the applying step.

3. The method of claim 2, wherein the separating occurs by at least one of decanting, centrifugation, ultra-centrifugation, filtration, ultra-filtration, precipitation, electrophoresis, reverse osmosis, sedimentation, incubation, treatment of the water source with acids, treatment of the water source with bases, treatment of the water source with coagulants and chelating agents, and combinations thereof.

4. The method of claim 1, wherein the contaminants comprise radionuclides.

5. The method of claim 4, wherein the radionuclides are selected from the group consisting of thallium, iridium, fluorine, americium, neptunium, gadolinium, bismuth, uranium, thorium, plutonium, niobium, barium, cadmium, cobalt, europium, manganese, sodium, zinc, technetium, strontium, carbon, polonium, cesium, potassium, radium, lead, actinides, lanthanides and combinations thereof.

6. The method of claim 1, wherein the contaminants comprise metals.

7. The method of claim 6, wherein the metals are selected from the group consisting of heavy metals, light metals, metal cations, metal oxides, metal halides, metal sulfates, metal hydroxides, mixed metal cations, zero valent metals, and combinations thereof.

8. The method of claim 6, wherein the metals are selected from the group consisting of iron, cobalt, copper, manganese, molybdenum, zinc, mercury, plutonium, lead, vanadium, tungsten, cadmium, chromium, arsenic, nickel, tin, thallium, aluminum, beryllium, bismuth, thorium, uranium, osmium, gold, and combinations thereof.

9. The method of claim 6, wherein the metals comprise actinides.

10. The method of claim 9, wherein the actinides are selected from the group consisting of actinium, thorium, protactinium, uranium, neptunium, plutonium, americium, curium, berkelium, californium, einsteinium, fermium, mendelevium, nobelium, lawrencium, and combinations thereof.

11. The method of claim 1, wherein the oxidatively modified carbon comprises an oxidized carbon source, wherein the carbon source is selected from the group consisting of coke, coal, charcoal, asphalt, asphaltenes, activated carbon, and combinations thereof.

12. The method of claim 11, wherein the carbon source is coke.

13. The method of claim 11, wherein the carbon source is coal.

14. The method of claim 11, wherein the coal is selected from the group consisting of anthracite, bituminous coal, sub-bituminous coal, metamorphically altered bituminous coal, asphalt, asphaltenes, peat, lignite, steam coal, petrified oil, and combinations thereof.

15. The method of claim 1, wherein the oxidatively modified carbon comprises oxidized coke.

16. The method of claim 1, wherein the oxidatively modified carbon has a three-dimensional structure.

17. The method of claim 1, wherein the oxidatively modified carbon is free-standing.

18. The method of claim 1, wherein the oxidatively modified carbon is in the form of particles.

19. The method of claim 18, wherein the particles have diameters ranging from about 1 μm to about 5 mm.

20. The method of claim 18, wherein the particles have diameters ranging from about 2 μm to about 100 μm.

21. The method of claim 1, wherein the oxidatively modified carbon has a surface area ranging from about 50 m²/g to about 200 m²/g.

22. The method of claim 1, wherein the oxidatively modified carbon comprises a plurality of pores.

23. The method of claim 1, wherein the oxidatively modified carbon comprises a plurality of layers.

24. The method of claim 1, wherein the oxidatively modified carbon is applied to the water source in solid form.

25. The method of claim 1, wherein the oxidatively modified carbon is applied to the water source in liquid form.

26. The method of claim 1, wherein the oxidatively modified carbon is applied to the water source by dispersing the oxidatively modified carbon in the water source.

27. The method of claim 1, wherein the oxidatively modified carbon is applied to the water source by flowing the water source through a structure housing the oxidatively modified carbon.

28. The method of claim 27, wherein the structure is a column.

29. The method of claim 27, wherein the structure is a filter.

30. The method of claim 27, wherein the structure is a cross-flow filtration system.

31. The method of claim 1, wherein the oxidatively modified carbon is applied to the water source while the oxidatively modified carbon is compartmentalized.

32. The method of claim 31, wherein the oxidatively modified carbon is compartmentalized in a porous container.

33. The method of claim 1, wherein the sorption comprises absorption of the contaminants to the oxidatively modified carbon.

34. The method of claim 1, wherein the sorption comprises adsorption of the contaminants to the oxidatively modified carbon.

35. The method of claim 1, wherein the sorption results in the capture of at least about 50% of the contaminants in the water source.

36. The method of claim 1, wherein the sorption results in the capture of at least about 90% of the contaminants in the water source.

37. A material for capturing contaminants from a water source, wherein the material comprises:
an oxidatively modified carbon comprising an oxidized carbon source,
wherein the carbon source is selected from the group consisting of coke, coal, charcoal, asphalt, asphaltenes, activated carbon, and combinations thereof,
wherein the oxidatively modified carbon has a three-dimensional structure, and
wherein the oxidatively modified carbon is in the form of particles.

38. The material of claim 37, wherein the carbon source is coal.

39. The material of claim 38, wherein the coal is selected from the group consisting of anthracite, bituminous coal, sub-bituminous coal, metamorphically altered bituminous coal, asphalt, asphaltenes, peat, lignite, steam coal, petrified oil, and combinations thereof.

40. The material of claim 37, wherein the carbon source is coke.

41. The material of claim 37, wherein the oxidatively modified carbon comprises oxidized coke.

42. The material of claim 37, wherein the particles have diameters ranging from about 1 μm to about 5 mm.

43. The material of claim 37, wherein the particles have diameters ranging from about 2 μm to about 100 μm

44. The material of claim 37, wherein the oxidatively modified carbon has a surface area ranging from about 50 m²/g to about 200 m²/g.

45. The material of claim 37, wherein the oxidatively modified carbon is free-standing.

46. The material of claim 37, wherein the oxidatively modified carbon comprises a plurality of pores.

47. The material of claim 37, wherein the oxidatively modified carbon comprises a plurality of layers.

48. A method of preparing an oxidatively modified carbon,
wherein the preparing comprises oxidizing a carbon source,
wherein the carbon source is selected from the group consisting of coke, coal, charcoal, asphalt, asphaltenes, activated carbon, and combinations thereof,
wherein the oxidatively modified carbon has a three-dimensional structure, and
wherein the oxidatively modified carbon is in the form of particles.

49. The method of claim 48, wherein the carbon source is coke.

50. The method of claim 48, wherein the carbon source is coal.

51. The method of claim 50, wherein the coal is selected from the group consisting of anthracite, bituminous coal, sub-bituminous coal, metamorphically altered bituminous coal, asphalt, asphaltenes, peat, lignite, steam coal, petrified oil, and combinations thereof.

52. The method of claim 48, wherein the oxidizing comprises exposing the carbon source to an oxidant.

53. The method of claim 52, wherein the oxidant is an anion.

54. The method of claim 52, wherein the oxidant is selected from the group consisting of permanganates, chlorates, perchlorates, hypochlorites, hypobromites, hypoiodites, chromates, dichromates, nitrates, nitric acid, sulfuric acid, oleum, chorosulfonic acid, and combinations thereof.

55. The method of claim 52, wherein the oxidant comprises a compound dissolved in an acid.

56. The method of claim 55, wherein the compound is selected from the group consisting of permanganates, chlorates, perchlorates, hypochlorites, hypobromites, hypoiodites, chromates, dichromates, nitrates, nitric acid, and combinations thereof.

57. The method of claim 55, wherein the acid is selected from the group consisting of sulfuric acid, nitric acid, oleum, chorosulfonic acid, and combinations thereof.

58. The method of claim 55,
wherein the compound is selected from the group consisting of potassium permanganate, sodium hypochlorite, potassium hypochlorite, potassium chlorate, nitric acid, and combinations thereof; and
wherein the acid is sulfuric acid.

59. The method of claim 58, wherein the oxidant is potassium permanganate dissolved in sulfuric acid.

60. The method of claim 55, wherein the oxidant is nitric acid dissolved in sulfuric acid.

61. The method of claim 48, wherein the particles have diameters ranging from about 1 μm to about 5 mm.

62. The method of claim 48, wherein the particles have diameters ranging from about 2 μm to about 100 μm

63. The method of claim 48, wherein the oxidatively modified carbon has a surface area ranging from about 50 m²/g to about 200 m²/g.

64. The method of claim 48, wherein the oxidatively modified carbon is free-standing.

65. The method of claim 48, wherein the oxidatively modified carbon comprises a plurality of pores.

66. The method of claim 48, wherein the oxidatively modified carbon comprises a plurality of layers.
